(19) United States
(12) Patent Application Publication
(10) Pub. No.: US 2025/0171036 A1
(43) Pub. Date: May 29, 2025

(54) VEHICLE CONTROL DEVICE, INQUIRY METHOD, STORAGE MEDIUM STORING PROGRAM, AND VEHICLE CONTROL SYSTEM

(71) Applicant: DENSO CORPORATION, Kariya-city (JP)

(72) Inventors: Yukihiro YAMAKAWA, Kariya-city (JP); Yusuke KANI, Kariya-city (JP); Satoshi NIWA, Kariya (JP)

(21) Appl. No.: 19/039,492

(22) Filed: Jan. 28, 2025

Related U.S. Application Data
(63) Continuation of application No. PCT/JP2023/025159, filed on Jul. 6, 2023.

(30) Foreign Application Priority Data
Aug. 2, 2022 (JP) 2022-123424

(51) Int. Cl. B60W 50/00; B60W 50/06; B60W 50/10

(52) U.S. Cl. CPC B60W 50/0098; B60W 50/06; B60W 50/10

(57) ABSTRACT

A vehicle control device mounted on a vehicle and configured to control the vehicle is configured to determine whether the first command is receivable when a first command from at least one application is input, output a second command based on the first command with respect to the first command determined to be receivable, determine whether there is the first command that is determined to be unreceivable for a predetermined period or more, and set an application that has output the first command as a target application in a case where the first command determined to be unreceivable for the predetermined period or more is present and the first command is not classified into a preset function related to safety of the vehicle, and inquire of a user whether to execute an operation of the target application.

### CROSS REFERENCE TO RELATED APPLICATION

The present application is a continuation application of International Patent Application No. PCT/JP2023/025159 filed on Jul. 6, 2023 which designated the U.S. and claims the benefit of priority from Japanese Patent Application No. 2022-123424 filed on Aug. 2, 2022. The entire disclosures of all of the above applications are incorporated herein by reference.

### TECHNICAL FIELD

The present disclosure relates to a vehicle control device.

### BACKGROUND

A related art discloses a vehicle arbitration system that includes a main manager and a sub manager and arbitrates requests from a plurality of applications to control an operation of a vehicle. The main manager receives a request from a first application execution section and determines a request for the sub manager. The main manager selects one request from among the plurality of received requests, sets an execution order of the plurality of received requests, and rejects the request. The sub manager arbitrates the request from a second application execution section and the request determined by the main manager. In a case where conflicting requests are simultaneously input, the sub manager selects one of the requests based on a selection criterion prepared in advance. In the vehicle arbitration system, in a case where a new function is added to the vehicle, the function can be easily expanded by adding an application that realizes the new function and the first application execution section that executes the application to the main manager.

### SUMMARY

A vehicle control device mounted on a vehicle and configured to control the vehicle is configured to determine whether the first command is receivable when a first command from at least one application is input, output a second command based on the first command with respect to the first command determined to be receivable, determine whether there is the first command that is determined to be unreceivable for a predetermined period or more, and set an application that has output the first command as a target application in a case where the first command determined to be unreceivable for the predetermined period or more is present and the first command is not classified into a preset function related to safety of the vehicle, and inquire of a user whether to execute an operation of the target application.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a vehicle control system;

FIG. 2 is a ladder chart illustrating the basic operation executed by the vehicle control system in the embodiment;

FIG. 3A is an image diagram of a priority order table;

FIG. 3B is an image diagram of another priority order table;

FIG. 4 is a ladder chart showing a basic operation in a case where an application that executes a request for the operation of a vehicle function related to a nonsafety function is added; and

FIG. 5 is a ladder chart showing a basic operation in a case where an application that executes a request for the operation of a vehicle function related to a high-level safety function is added.

### DETAILED DESCRIPTION

As a result of detailed examination by the inventor, in the vehicle arbitration system described in a related art, there is a problem that there is a possibility that an application desired by the user is constantly arbitration lost in the main manager or the sub manager and is not executed. However, when the user simply prioritizes execution of a desired application, the safety of the vehicle may not be maintained.

An aspect of the present disclosure provides a vehicle control device capable of preferentially executing an application desired by a user while maintaining safety of a vehicle.

According to one aspect of the present disclosure, a vehicle control device mounted on a vehicle and configured to control the vehicle includes a reception determination section, an output section, a period determination section, and a notification section. The reception determination section is configured to, when a first command from at least one application is input, determine whether the first command is receivable. The output section is configured to output, to an operation control section for controlling an object to be controlled, a second command based on the first command with respect to the first command determined to be receivable. The period determination section is configured to determine whether there is the first command that is determined to be unreceivable for a predetermined period or more. The notification section is configured to, in a case where the first command determined by the period determination section to be unreceivable for the predetermined period or more is present and the first command is not classified into a preset function related to safety of the vehicle, set an application that has output the first command as a target application, and inquire of a user whether to execute an operation of the target application.

According to such a configuration, it is possible to preferentially execute an application desired by the user while maintaining the safety of the vehicle.

Hereinafter, exemplary embodiments of the present disclosure will be described with reference to the drawings.

### 1. Embodiment

### (1-1. Correspondence Between Configuration of Embodiment and Configuration of Present Disclosure)

In the following embodiment, an ECUA 10 corresponds to a vehicle control device in the present disclosure. The processing of a request arbitration section 711 in the embodiment corresponds to functions of the reception determination section, the output control section, and the execution priority section in the present disclosure. The processing of an arbitration priority management section 712 in the embodiment corresponds to functions of the table additional writing section and the table changing section in the present disclosure. The processing of an arbitration result management section 713 in the embodiment corresponds to functions of the period determination section and the notification section in the present disclosure.

### (1-2. Configuration)

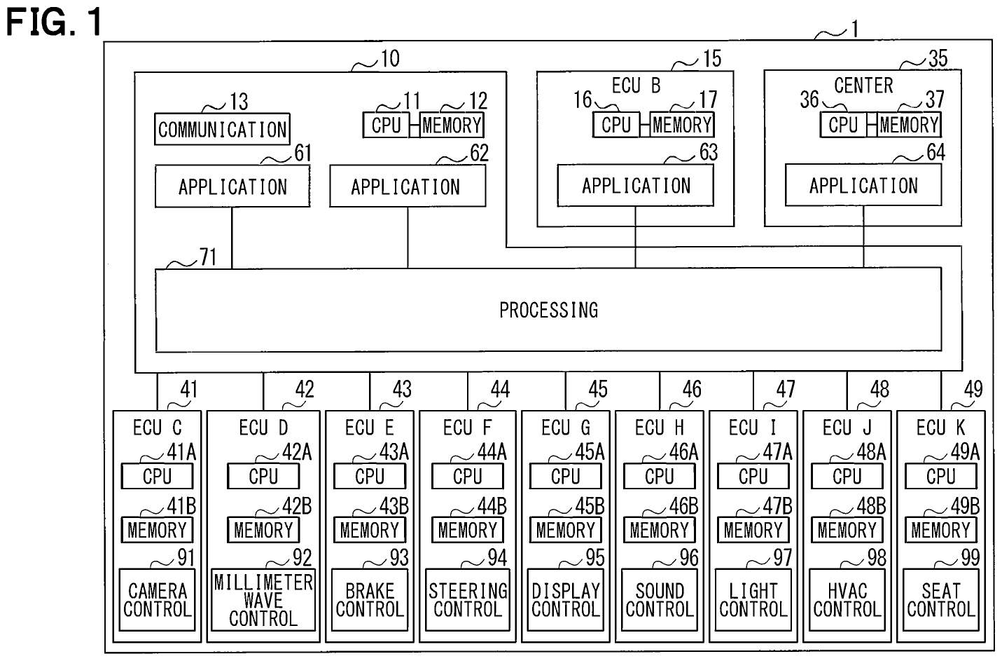

Most of the components of a vehicle control system 1 illustrated in FIG. 1 are mounted on a vehicle such as a passenger car and includes a plurality of ECUs 10, 15, and 41 to 49 (hereinafter, a large number of ECUs 10 and the like). The vehicle control system 1 may include a center 35 outside the vehicle. The large number of ECUs 10 and the like are communicably connected via a network in the vehicle centered on the ECU 10. The center 35 is also communicably connected via a network in the vehicle.

The center 35 is configured as a server capable of providing a function to the vehicle. The center 35 can provide the vehicle with a function related to automated driving, for example.

The large number of ECUs 10 and the like and the center 35 are mainly configured by a known microcomputer having CPUs 11, 16, 36, and 41A to 49A (hereinafter, the CPUs 11 to 49A) and semiconductor memories 12, 17, 37, and 41B to 49B (hereinafter, the memory 12 to 49B) such as a RAM, a ROM, and a flash memory. The ECU represents an electronic control device.

Among the large number of ECUs 10 and the like, the ECUA 10 includes a communication section 13 configured as a communication module such as a well-known transceiver. The ECUA 10 has a relay function of relaying communication between other devices (for example, other ECUs) in the vehicle connected to the ECU 10A using the communication section 13.

The ECU 10A communicates with a large number of ECUs 10 and the like and integrates the large number of ECUs 10 and the like, thereby implementing control in cooperation with the entire vehicle. A large number of ECUs 10 and the like are provided for each domain divided according to functions in the vehicle, and mainly execute control of a plurality of ECUs existing in the domain. The ECU 10A is connected to the subordinate ECUs 41 to 49 via, for example, a lower layer network communicated by a CAN. The CAN is an abbreviation for a controller area network. The CAN is a registered trademark. The domain is, for example, a powertrain, a body, a chassis, a cockpit, or the like.

The ECU belonging to the domain of the powertrain may include, for example, an ECU that controls an engine, an ECU that controls a motor, an ECU that controls a battery, and the like.

The ECU belonging to the body domain includes, for example, an ECUJ 48 that controls an air conditioner and an ECUK 49 that controls a seat. The ECU belonging to the domain of the body may include an ECU that controls a door.

The ECUs belonging to the chassis domain include, for example, an ECUE 43 that controls the brake, an ECUF 44 that controls the steering, and the like.

The large number of ECUs 10 and the like and the center 35 are configured to control an object to be controlled mounted on the vehicle based on a second command output inside a processing section 71. Examples of the object to be controlled include an engine, a brake, a motor, various lights, a display device, an air conditioner, a seat, a horn, and a power generator. Note that illustration of the object to be controlled is omitted.

The object to be controlled is individually controlled by the ECU 41 to 49 which is an operation control device. The ECUs 41 to 49 includes the ECUC 41 including a camera control section 91, the ECUD 42 including a millimeter wave control section 92, the ECUE 43 including a brake control section 93, and the ECUF 44 including a steering control section 94. The ECUG 45 including a display control section 95, the ECUH 46 including a sound control section 96, the ECUI 47 including a light control section 97, the ECUJ 48 including a HVAC control section 98, and the ECUK 49 including a seat control section 99 are included.

Each control section 91 to 99 includes an operation control section for operating the object to be controlled. The operation control section is, for example, an operation control program. The camera control section 91 acquires a captured image of the in-vehicle camera, and controls exposure and the like of the in-vehicle camera. The millimeter wave control section 92 controls a millimeter wave radar provided in the vehicle and acquires a detection result obtained by the millimeter wave radar.

The brake control section 93 controls the brake. The steering control section 94 controls steering. The display control section 95 controls an indicator such as a meter or a warning light. The sound control section 96 controls sounds such as a warning sound and a voice generated from the speaker. The light control section 97 controls various lights mounted on the vehicle.

The HVAC control section 98 controls the in-vehicle air conditioner. The HVAC is an abbreviation for Heating Ventilation and Air-Conditioning. The seat control section 99 controls an electric power seat of the vehicle.

Various functions of a large number of ECUs 10 and the like and the center 35 are realized by the CPUs 11 to 49A executing programs stored in a non-transitory tangible recording medium. In this example, each of the memories 12 to 49B corresponds to a non-transitory tangible recording medium storing a program. By executing this program, a method corresponding to the program is executed. Note that the non-transitory tangible recording medium means the recording medium from which electromagnetic waves are excluded. The number of microcomputers constituting the large number of ECUs 10 and the like and the center 35 may be one or more.

The ECUA 10 implements functions as applications (hereinafter, an application) 61 and 62 and the processing section 71 by executing programs. An ECUB 15 realizes a function as an application 63. The center 35 realizes a function as an application 64.

The applications 61 to 64 are programs for providing a service to a user of the vehicle. The applications 61 to 64 indirectly transmit a command to the object to be controlled and operates the object to be controlled to provide a useful function to the user. These applications 61 to 64 may be installed in the ECUA 10, the ECUB 15, or the center 35.

More specifically, the applications 61 to 64 is configured to generate a first command that is a command not designating the control section 91 to 99 described later to the processing section 71. Note that the “command” includes a command such as an operation request, a command such as an argument, a function call, and the like among the data used in the processing section 71. The “command” may include priority information indicating which command should be preferentially processed.

The applications 61 to 64 is not a program created specifically for vehicle types, grades, and the like, but is a general-purpose program that can support many vehicle types, grades, and the like. Therefore, the applications 61 to 64 cannot identify how the mounted vehicle controls the object to be controlled. Therefore, the applications 61 to 64 outputs a command not designating a control amount of the specific object to be controlled, in other words, the control section 91 to 99 used by the processing section 71. On the other hand, the applications 61 to 64 generate a desired abstract operation content. For example, the applications 61 to 64 only instructs the operation content of “turning on the light”, and does not specifically include which light is to be turned on in the operation content.

Hereinafter, at least one of the applications 61 to 64 is also referred to as a service application 6.

Unlike the applications 61 to 64, the processing section 71 has a program created specifically for a vehicle type, a grade, and the like. That is, the processing section 71 includes a program that absorbs the difference in vehicle type, grade, and the like so that the applications 61 to 64 does not need to be aware of the difference in vehicle type, grade, and the like.

The processing section 71 is mounted on the ECUA 10. The processing section 71 receives commands from the ECUA 10 of its own, the ECUB 15 that is another ECU, and a plurality of applications 61 to 64 mounted on the center 35.

The processing section 71 includes functional blocks realized by the CPU 11 executing a program, that is, the request arbitration section 711, the arbitration priority management section 712, and the arbitration result management section 713 as virtual components. The processes in the request arbitration section 711, the arbitration priority management section 712, and the arbitration result management section 713 will be described in detail later.

The processing section 71 is also a program for controlling an object to be controlled. For example, the processing section 71 calculates an operation amount of an actuator that is an object to be controlled, and transmits a command including the operation amount to the various control sections 91 to 99. That is, the processing section 71 has a function of generating a second command embodying the first command when the abstracted first command is input. For example, when a first command to turn on the light is input from the applications 61 to 64, the processing section 71 generates a specific second command to turn on which light. More specifically, for example, the processing section 71 recognizes what type of equipment the vehicle is equipped with, and selects the type of light to be turned on according to the type of equipment the vehicle is equipped with. Then, the processing section 71 sets the lighting pattern (for example, an interval at the time of blinking, and the like) of each selected light to transmit a second command including the lighting pattern to each control section 91 to 99 that controls the light to be lit.

The processing section 71 is also a program for transmitting data obtained from a sensor or the like to the service application 6. In other words, the processing section 71 realizes a function of “state recognition” and a function of “equipment control”. In the function of state recognition, sensor data obtained from each control section 91 to 99 to be described later is converted into a format suitable for the processing section 71. In the function of equipment control, a drive instruction from the processing section 71 is distributed to each control section 91 to 99.

In the function of state recognition, a function of classifying individual sensor raw data acquired from the vehicle sensor into data for each sensing target that is easy for the service application 6 to use is realized. In addition, data integration is performed, and conversion into information with a higher abstraction level is performed.

For example, in the function of state recognition, each control section 91 to 99 acquires individual information such as a vehicle speed of 0 km/h, a shift position P, and absence of a driver in the vehicle to output information indicating that the vehicle is in a parking state based on these pieces of information. This information is transmitted to the service application 6.

For example, in a case where the service application 6 makes a request for a car finder, the processing section 71 may combine ack from the light and ack from the horn, which are responses to the request for controlling the light and the horn, into one operation result and respond to the service application 6. Note that the car finder is a function of an application that notifies the user of the position of the vehicle such as a parking lot in an easy-to-understand manner.

In the function of equipment control, each control section 91 to 99 (for example, an engine, a steering, a shift, a door, a window, an air conditioner, or the like) optimal for realizing the vehicle operation request from the service application 6 is selected. Then, the format is converted into a format of data that can be received by each control section 91 to 99, and the data is distributed in consideration of the order of transmission of the data.

For example, when the vehicle operation request is “accelerate the vehicle at 0.3 G while turning at the left radius of 200 m”, “a request for the engine to output 1000 Nm and a request for the steering to output −0.1 rad” is output in the function of the equipment control.

Further, for example, it is assumed that the vehicle operation request is “shift to parking state”. In this case, in the function of equipment control, “request that the shift is set to P, request the air conditioner to be turned off, request the window to be fully closed, request the door to shift to a lock request parking state when the request is completed and no occupant is present” is output.

### (1-3. Process)

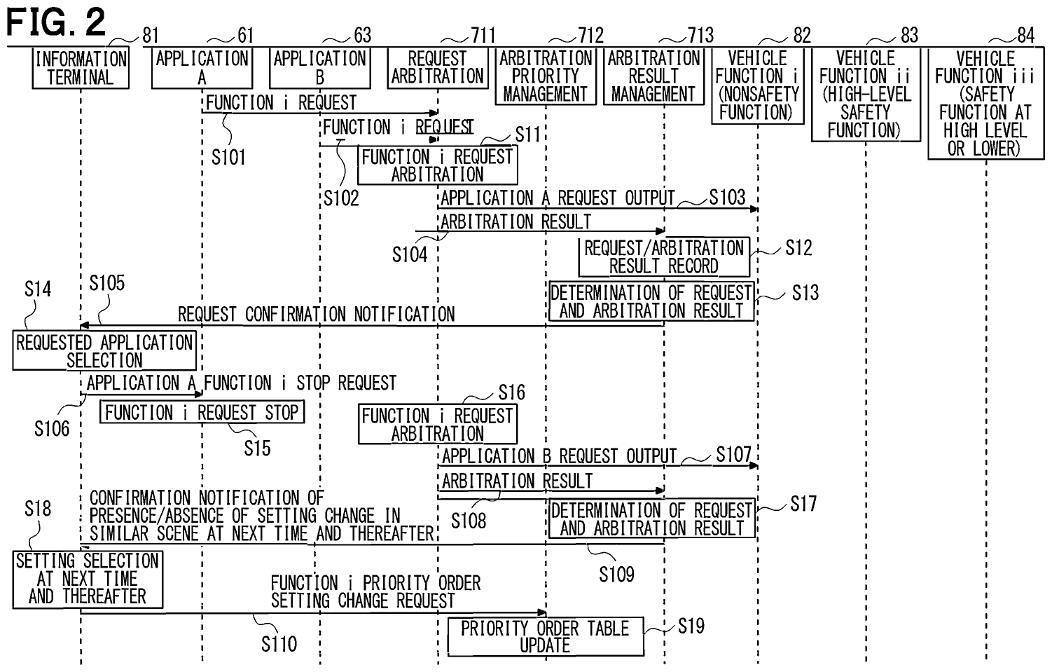

Next, basic processing executed by the vehicle control system 1 will be described with reference to a ladder chart of FIG. 2. This process is a process when a request for the operation of the vehicle function i related to the nonsafety function are transmitted from a different service application 6. Here, for example, an automotive safety level (ASIL) is used to classify whether the function is the safety function or the nonsafety function. The ASIL is a risk classification system defined in the ISO 26262 standard for functional safety of vehicles traveling on roads. The ASIL is determined by three parameters of probability of exposure, controllability, and severity, and is expressed in four stages of A to D. A is associated with the lowest level and D is associated with the highest level. In the present embodiment, ASIL A is classified into a vehicle function i related to a nonsafety function, ASIL D is classified into a vehicle function ii related to a high-level safety function, and ASIL B and ASIL C are classified into a vehicle function iii related to a high-level or lower safety function. In the classification of the safety function, the ASIL is not necessarily used, and it is sufficient that the safety level is defined so as to have a plurality of levels. Therefore, the safety level does not need to have four stages A to D, and may have three stages or less, or five stages or more. Hereinafter, the “safety function” is also referred to as a “function related to vehicle safety”.

In S101, the application 61 having the application A transmits a request for the operation of the vehicle function i (that is, the first command in the present disclosure) to the request arbitration section 711. At substantially the same time, the application 63 having the application B also transmits the request for the operation of the vehicle function i to the request arbitration section 711 in S102.

In S11, the request arbitration section 711 determines which first command is receivable. Specifically, the request arbitration section 711 refers to the priority order table to determine which first command is executable. The priority order table is a table in which the priority order is associated with each application or each type of request from the application.

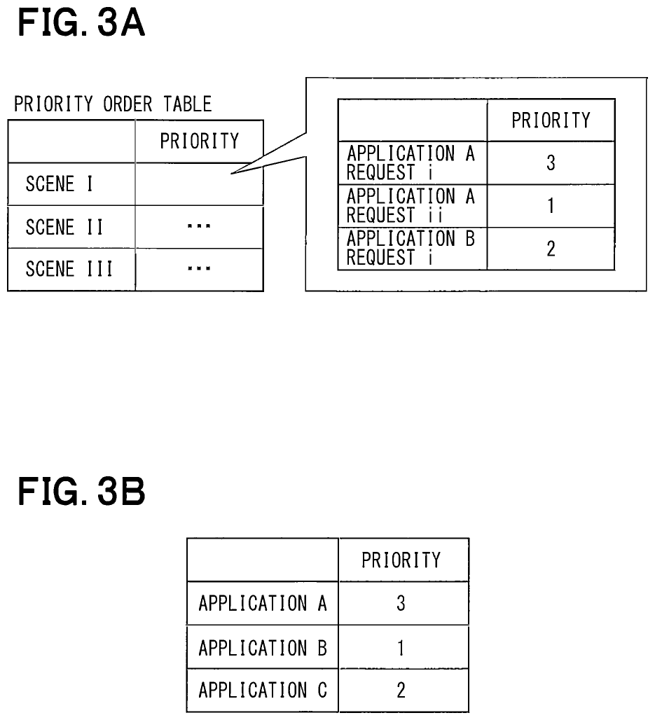

For example, as shown in FIG. 3A, the priority order table manages the priority order of the vehicle functions requested by the application for each scene. The scene is classified according to, for example, a traveling state. The scenes may be classified according to a power state of the vehicle equipment, a traveling load, an automation level, and the like. In addition, the vehicle function i requested by the application is classified, for example, for each type of request from the application (for example, the application A request i, the application A request ii, and the like).

The request arbitration section 711 determines that the first command is receivable for the vehicle function i having a higher priority order. That is, the vehicle function i having a higher priority order is set to have a higher priority order when the corresponding application is executed.

Note that the table illustrated in FIG. 3A is a table in which the priority order is associated with each type of request from the application. For this reason, there may be a situation in which a plurality of requests from one application is partially executed, and then execution of another part of requests is in standby. In this case, during this standby, another process with a higher priority order can be completed earlier.

As illustrated in FIG. 3B, a table in which the priority order is associated with each application instead of each request type may be provided, and this table may be used together with the table illustrated in FIG. 3A. In a case where the table illustrated in FIG. 3B is used, the request arbitration section 711 can execute the process according to the priority order set for each application. In this case, it is possible to prevent a plurality of processes of the application from being interrupted in the middle.

With respect to the first command determined to be receivable in S103, the request arbitration section 711 outputs a second command based on the first command to the operation control section for controlling the object to be controlled. In the present embodiment, the request arbitration section 711 determines that the request for the operation of the vehicle function i transmitted from the application 61 is receivable to output the second command to the vehicle function i.

In addition, in S104, the request arbitration section 711 transmits an arbitration result indicating that the first command of the application 61 is receivable and the first command of the application 63 is unreceivable to the arbitration result management section 713.

In S12, the arbitration result management section 713 records the arbitration result. At this time, the arbitration result management section 713 counts the number of times the first command of the application 63 is unreceivable, and stores the count in the memory 12.

Subsequently, in S13, the arbitration result management section 713 determines whether there is the first command determined to be unreceivable for a predetermined period or more. In the present embodiment, the arbitration result management section 713 determines whether there is the first command determined to be unreceivable a preset number of times or more as the predetermined period.

Note that the predetermined period is not limited to a preset number of times, and may be a preset period. In addition, the predetermined period may be set to a different value for each application, for each command from the application, or the like. In addition, the predetermined period may be set each time by executing an arithmetic operation or the like based on a condition when the arbitration result management section 713 executes processing, in addition to for each application, each command from the application.

The arbitration result management section 713 inquires of the user whether to execute the target application in a case where there is a first command determined to be unreceivable for a predetermined period or more and the first command is not classified into a preset function related to safety of the vehicle in S105. Note that the application that has output the first command is a target application. In the present embodiment, the arbitration result management section 713 uses the application B as a target application and inquires of the user whether to execute the target application. As an example, the inquiry is executed while the vehicle is stopped. This is to allow the user to execute an answer to the inquiry more safely.

In a case where the answer to the inquiry is received and the user replies to execute the target application in S14, an information terminal 81 requests to stop another application that conflicts with the target application in S106. In the present embodiment, the information terminal 81 requests to stop the application A, and the application 61 stops the request for the operation of the vehicle function i for the application A in S15.

In S16, the request arbitration section 711 determines again which first command is receivable.

The request arbitration section 711 outputs a second command based on the first command to the operation control section for controlling the object to be controlled with respect to the first command determined to be receivable as a result of the determination again in S107. In the present embodiment, the request arbitration section 711 determines that the request for the operation of the vehicle function i transmitted from the application 63 is receivable to output the second command to the vehicle function i.

In addition, in S108, the request arbitration section 711 transmits an arbitration result indicating that the first command of the application 63 is receivable to the arbitration result management section 713.

Subsequently, in S17, as in S13, the arbitration result management section 713 determines whether there is the first command determined to be unreceivable for a predetermined period or more.

In a case where there is no first command determined to be unreceivable for a predetermined period or more, the arbitration result management section 713 inquires of the user whether to change the setting of the priority order in the similar scene at the next time or thereafter in S109.

In S18, an answer to the inquiry about the next or subsequent setting is received, and in S110, the information terminal 81 requests to change the priority order of the vehicle function i.

In S19, the arbitration priority management section 712 updates the priority order table based on the answer of the user.

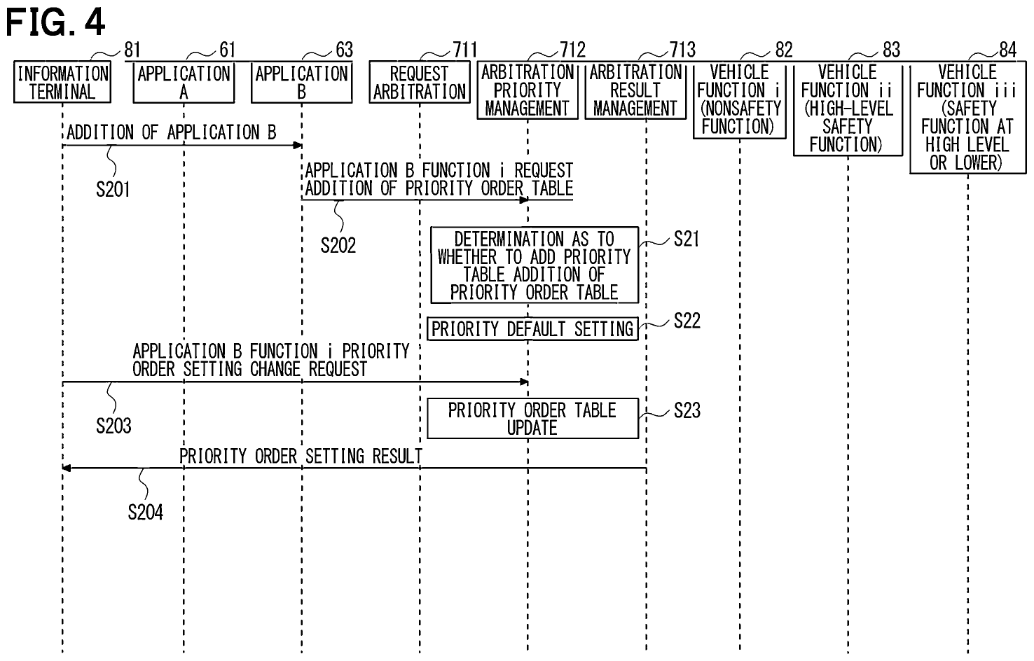

Next, an operation example when a new application is added will be described with reference to a ladder chart of FIG. 4. In this process, a case where an application that executes a request for the operation of the vehicle function i related to the nonsafety function is added will be described.

When the application B is newly added from the information terminal 81 in S201, the application 63 requests the arbitration priority management section 712 to add the vehicle function i requested by the application B to the priority order table in S202.

In S21, the arbitration priority management section 712 determines whether to add to the priority order table. Specifically, the arbitration priority management section 712 determines whether the vehicle function (hereinafter, referred to as an additional function) requested to be added to the priority order table is a function related to vehicle safety. In a case where the additional function is a function related to vehicle safety, the arbitration priority management section 712 does not permit addition to the priority order table. For example, in a case where the additional function has a high-level safety function like the vehicle function ii, the addition to the priority order table is not permitted. This is because, in a case where the additional function is a function related to safety of the vehicle, the additional function should be executed with the highest priority order, and the priority order should not be changed to a lower level. In the present embodiment, in a case where the additional function is the vehicle function i, since the vehicle function i is a nonsafety function and does not correspond to a function related to vehicle safety, addition of the additional function to the priority order table is permitted.

In S22, the arbitration priority management section 712 adds the new application and the default priority order in the priority order table in association with each other. At this time, a type of a request that can be transmitted from a new application and a default priority order may be added to the priority order table in association with each other.

In a case where the change in the priority order is requested by the operation by the user in S203, the arbitration priority management section 712 changes the priority order described in the priority order table from the default priority order to the priority order instructed by the operation by the user in S23.

Subsequently, in S204, the arbitration priority management section 712 transmits the changed priority order to the information terminal 81.

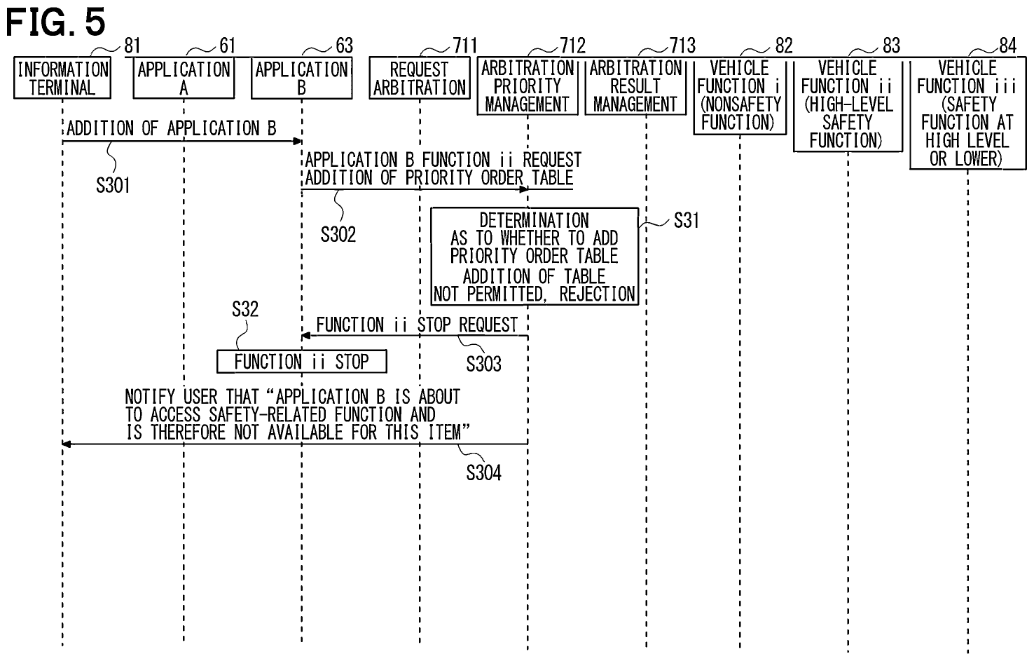

Next, another operation example in a case where a new application is added will be described with reference to the ladder chart of FIG. 5. In this process, a case where an application that executes a request for the operation of the vehicle function ii related to the high-level safety function is added will be described.

When the application B is newly added from the information terminal 81 in S301, the application 63 requests the arbitration priority management section 712 to add the vehicle function ii requested by the application B to the priority order table in S302.

In S31, the arbitration priority management section 712 determines whether to add to the priority order table as in S21. In the present embodiment, since the vehicle function ii is a high-level safety function and corresponds to a function related to safety of the vehicle, the addition to the priority order table is rejected.

Subsequently, the arbitration priority management section 712 stops the request for adding the vehicle function ii to the priority order table in S303, and the application 63 stops the request in S32.

In addition, the arbitration priority management section 712 notifies the user that the application B cannot be added to the priority order table because of the function related to safety.

### (1-4. Effects)

According to the embodiment described in detail above, the following effects can be obtained.

(1a) In S13, the arbitration result management section 713 determines whether there is the first command determined to be unreceivable a preset number of times or more. Then, the arbitration result management section 713 inquires of the user whether to execute the target application in a case where there is the first command determined to be unreceivable for a preset number of times or more and the first command is not classified into a preset function related to safety of the vehicle in S105. According to such a configuration, it is possible to avoid a situation in which an application desired by the user is not executed a preset number of times or more. In addition, the safety of the vehicle can be maintained by configuring the function related to the safety of the vehicle to be preferentially executed without inquiring of the user. Therefore, it is possible to preferentially execute the application desired by the user while maintaining the safety of the vehicle.

(1b) In a case where the user replies that the target application is executed, the request arbitration section 711 preferentially executes the target application, compared with another application by receiving the first command by the target application in S107. According to such a configuration, it is possible to avoid a situation in which the target application is not executed beyond the predetermined period.

(1c) In a case where the user replies to execute the target application, the information terminal 81 requests to stop another application that conflicts with the target application in S106. According to such a configuration, since another conflicting application is stopped, the target application can be immediately executed.

(1d) When a new application is added, the arbitration priority management section 712 additionally writes the new application and the priority order in the priority order table in association with each other in S22. In addition, in S11, the request arbitration section 711 refers to the priority order table to determine which first command is executable. According to such a configuration, the priority order of the application can be managed by a simple method. When a new application is added, the type of the command from the application and the priority order may be added to the priority order table in association with each other.

(1e) In a case where the change in the priority order for the vehicle function i is requested by the operation by the user in S203, the arbitration priority management section 712 can change the priority order described in the priority order table in S23. On the other hand, in S31, since the vehicle function ii is a high-level safety function and corresponds to a function related to safety of the vehicle, the addition to the priority order table is rejected, and the priority order cannot be changed. According to such a configuration, it is possible to set the priority order according to the intention of the user. In addition, since the priority order is not set to be lower for the function related to the safety of the vehicle, the safety of the vehicle can be maintained.

### 2. Other Embodiments

Although the embodiment of the present disclosure has been described above, it is needless to say that the present disclosure is not limited to the above embodiments and can take various forms.

(2a) In the above embodiment, the configuration in which the arbitration result management section 713 determines whether there is the first command determined to be unreceivable the preset number of times or more in S13 has been exemplified. That is, the number of times of arbitration loss is counted, and this count value is used as an arbitration loss period to determine whether reception is possible. However, the method of determining whether there is the first command determined to be unreceivable for a predetermined period or more is not limited thereto. For example, the arbitration result management section 713 may determine whether there is the first command determined to be unreceivable for a certain period of time or more. That is, a time during which arbitration is lost may be measured, and this time may be used as an arbitration loss period to determine whether reception is possible. In addition, the preset number of times or a certain period of time may be a fixed value, or may be different for each type of application. In addition, the preset number of times or a certain period of time may be changed according to the situation.

(2b) In the above embodiment, the configuration in which the arbitration result management section 713 inquires of the user whether to execute the target application while the vehicle is stopped in S105 has been exemplified. However, the timing of making an inquiry to the user is not limited thereto. For example, the arbitration result management section 713 may make a notification in at least one of a situation where the vehicle is stopped and a situation where the vehicle is traveling, and make a method of inquiring to the user different between the situation where the vehicle is stopped and the situation where the vehicle is traveling. As an example, it is preferable that the inquiry content is displayed on the monitor while the vehicle is stopped, and the inquiry content is notified by voice while the vehicle is traveling. According to such a configuration, it is possible to make an inquiry to the user by a method suitable for the situation.

(2c) In the above embodiment, the configuration in which in a case where an answer to the inquiry is received and the user replies to execute the target application in S14, the information terminal 81 requests to stop another application that conflicts with the target application in S106 has been exemplified. However, the configuration in which the target application is executed in preference to another application is not limited thereto. For example, the information terminal 81 may request execution of the target application without requesting stop of another application that conflicts with the target application. As a result, when the target application is executed, another application that conflicts with the target application may be stopped.

(2d) In the above embodiment, the configuration in which the addition to the priority order table is not permitted in a case where the vehicle function corresponds to a function related to the safety of the vehicle has been exemplified. However, even in a case where the vehicle function corresponds to a function related to the safety of the vehicle, the addition to the priority order table may be permitted. However, in a case where the vehicle function corresponds to a function related to vehicle safety, it is preferable that the priority order cannot be changed. According to such a configuration, the priority order of the functions related to the safety of the vehicle is not set to a lower level, so that the safety of the vehicle can be maintained. Note that the priority order of applications classified into functions related to vehicle safety is set higher than the priority order of applications not classified into functions related to vehicle safety. For example, an application classified into a function related to vehicle safety is set so as not to be arbitration lost. As a result, arbitration loss can be avoided for an application classified into a function related to vehicle safety, and intention of the user can be reflected for an application not classified into a function related to vehicle safety.

(2e) In the above embodiment, the configuration in which the arbitration result management section 713 inquires of the user whether to execute the target application using the application B as the target application in S105 has been exemplified. That is, the configuration of inquiring whether to permit execution of the application itself has been exemplified. In a case where execution was permitted, priority was given to execution of the entire application temporarily or permanently. However, the vehicle control system 1 may be configured to inquire whether to permit execution of some operations executed by the application. In a case where execution is permitted, some operations executed by the application may be prioritized temporarily or permanently. For example, a case is considered in which a driving instruction application that monitors the driving situation of the user and performs driving diagnosis and a music playback application that plays music are being executed. In this case, when the voice output of the driving advice in the driving instruction application is arbitration lost, it may be inquired whether to permit the execution of the voice output. Even when the execution of the voice output is not permitted, the driving instruction application itself may continue to operate.

(2f) The multiple ECUs 10 and the methods thereof described in the present disclosure may be implemented by a dedicated computer provided by a processor and memory programmed to perform one or more functions implemented by a computer program. Alternatively, the multiple ECUs 10 and the methods thereof described in the present disclosure may be implemented by a dedicated computer provided by a processor with one or more dedicated hardware logic circuits. Alternatively, the multiple ECUs 10 and the method thereof described in the present disclosure may be implemented by one or more special purpose computers configured by a combination of a processor and a memory programmed to execute one or multiple functions and a processor configured by one or more hardware logic circuits. The computer program may be stored in a computer-readable non-transitory tangible storage medium as instructions to be executed by a computer. The method for implementing the functions of respective units included in the multiple ECUs 10 does not necessarily need to include software, and all of the functions may be implemented with the use of one or more hardware circuits.

(2g) Multiple functions of one component in the above embodiment may be implemented by multiple components, and a function of one component may be implemented by multiple components. Further, multiple functions possessed by multiple components may be implemented by one component, or one function implemented by multiple components may be implemented by one component. A part of the configuration of the above embodiments may be omitted as appropriate. At least some of the configurations of the above embodiments may be added to or replaced with the configurations of other embodiments.

(2h) In addition to the vehicle control system 1 described above, the present disclosure can also be implemented in various manners, such as the ECUs 10 configuration the vehicle control system 1, a vehicle control program for causing a computer to function as the ECUs 10, a non-transitory tangible storage medium such as a semiconductor memory in which the program is recorded, and a vehicle control method.

What is claimed is:

1. A vehicle control device mounted on a vehicle and configured to control the vehicle, the vehicle control device comprising:
a reception determination section configured to, when a first command from at least one application is input, determine whether the first command is receivable;
an output section configured to output, to an operation control section for controlling an object to be controlled, a second command based on the first command with respect to the first command determined to be receivable;
a period determination section configured to determine whether there is the first command that is determined to be unreceivable for a predetermined period or more; and
a notification section configured to, in a case where the first command determined by the period determination section to be unreceivable for the predetermined period or more is present and the first command is not classified into a preset function related to safety of the vehicle, set an application that has output the first command as a target application, and inquire of a user whether to execute an operation of the target application.

2. The vehicle control device according to claim 1, further comprising:
an execution priority section configured to cause the reception determination section to receive the first command by the target application in a case where an answer to an inquiry by the notification section is received and the user replies that an operation of the target application is to be executed to execute the operation of the target application with priority over an operation of another application.

3. The vehicle control device according to claim 2, wherein
the execution priority section causes the reception determination section to determine that the target application is receivable by stopping another application that conflicts with the target application.

4. The vehicle control device according to claim 1, further comprising:
a table additional writing section including a priority order table in which a priority order is associated with each application, and configured to, when a new application is added, additionally write the new application and the priority order in association with each other in the priority order table,
wherein
the reception determination section determines whether the first command is executable with reference to the priority order table.

5. The vehicle control device according to claim 1, further comprising:
a table additional writing section including a priority order table in which a priority order is associated with a type of a command from an application, and configured to, when a new application is added, additionally write a type of the command with respect to the new application and the priority order in association with each other in the priority order table,
wherein
the reception determination section determines whether the first command is executable with reference to the priority order table.

6. The vehicle control device according to claim 4, further comprising:
a table changing section configured to be able to change the priority order described in the priority order table by an operation by the user,
wherein
the table changing section is not allowed to change the priority order of a function related to safety of the vehicle.

7. The vehicle control device according to claim 1, wherein
the notification section makes a notification in at least one of a situation where the vehicle is stopped and a situation where the vehicle is traveling, and makes a method of inquiring to the user different between the situation where the vehicle is stopped and the situation where the vehicle is traveling.

8. The vehicle control device according to claim 1, wherein
a priority order is set in advance for each application,
a priority order of an application classified into a function related to vehicle safety is set higher than a priority order of an application not classified into the function related to vehicle safety, and
the reception determination section determines whether the first command is executable with reference to the priority order.

9. An inquiry method implemented by a vehicle control device mounted on a vehicle and configured to control the vehicle, the inquiry method comprising:
determining whether a first command is receivable when the first command from at least one application is input;
outputting, to an operation control section for controlling an object to be controlled, a second command based on the first command with respect to the first command determined to be receivable;
determining whether there is the first command that is determined to be unreceivable for a predetermined period or more; and
setting an application that has output the first command as a target application in a case where the first command determined to be unreceivable for a predetermined period or more is present and the first command is not classified into a preset function related to safety of the vehicle, and inquiring of a user whether to execute an operation of the target application.

10. A non-transitory computer readable storage medium storing a program for causing a computer mounted on a vehicle to execute:
a function of, when a first command from at least one application is input, determining whether the first command is receivable;
a function of outputting, to an operation control section for controlling an object to be controlled, a second command based on the first command with respect to the first command determined to be receivable;
a function of determining whether there is the first command that is determined to be unreceivable for a predetermined period or more; and
a function of setting an application that has output the first command as a target application in a case where the first command determined to be unreceivable for a predetermined period or more is present and the first command is not classified into a preset function related to safety of the vehicle, and inquiring of a user whether to execute an operation of the target application.

11. A vehicle control system mounted on a vehicle, the vehicle control system comprising:
a vehicle control device configured to control the vehicle and having a relay function in a network in the vehicle; and
an electronic control device communicably connected to the vehicle control device via the network,
wherein
the vehicle control device includes
a reception determination section configured to, when a first command from at least one application is input, determine whether the first command is receivable,
an output section configured to output, to the electronic control device that controls an object to be controlled, a second command based on the first command with respect to the first command determined to be receivable,
a period determination section configured to determine whether there is the first command that is determined to be unreceivable for a predetermined period or more, and
a notification section configured to, in a case where the first command determined by the period determination section to be unreceivable for the predetermined period or more is present and the first command is not classified into a preset function related to safety of the vehicle, set an application that has output the first command as a target application, and inquire of a user whether to execute an operation of the target application, and
the electronic control device includes a control sections configured to execute control of the object to be controlled based on the second command output from the output section.
